(19) United States
(12) Patent Application Publication
(10) Pub. No.: US 2018/0161926 A1
(43) Pub. Date: Jun. 14, 2018

(54) COMBINED MACHINING APPARATUS AND LASER SPECTROSCOPIC DEVICE THEREOF

(71) Applicant: TONGTAI MACHINE & TOOL CO.,LTD., KAOHSIUNG CITY (TW)

(72) Inventors: CHIH-HSIANG YANG, KAOHSIUNG CITY (TW); HSIN-PAO CHEN, KAOHSIUNG CITY (TW); JUI-HSIUNG YEN, KAOHSIUNG CITY (TW)

(21) Appl. No.: 15/825,121

(22) Filed: Nov. 29, 2017

(30) Foreign Application Priority Data
Dec. 14, 2016 (CN) 201611151616.4

(51) Int. Cl. B23K 26/067; B23K 26/08; B23K 26/00; B23K 26/38; B23K 26/046; B23K 26/06; B23P 25/00; B26D 5/00

(52) U.S. Cl. CPC B23K 26/0673; B23K 26/0861; B23K 26/0093; B26D 5/005; B23K 26/046; B23K 26/0648; B23P 25/006; B23K 26/38

(57) ABSTRACT

A combined machining apparatus and a laser spectroscopic device thereof are provided. The machining vehicle has a machining platform, a machining device and a laser spectroscopic device. The time of a workpiece machined by the composite machine can be effectively reduced by producing a plurality of laser beams to the workpiece from the laser spectroscopic device, and by selectively assembling a tool head or a feeding head onto the machining device.

### FIELD OF THE INVENTION

The present disclosure relates to a machining apparatus and a laser spectroscopic device thereof, and in particular to a combined machining apparatus and a laser spectroscopic device thereof used in computer numerical control machine.

### BACKGROUND OF THE INVENTION

Traditional machines are mainly controlled to feed material to machine a workpiece according to operation technology of operators. Therefore, the quality of the workpiece is affected by human factors, and there are disadvantages of high cost and low productivity. With the development of a computer numerical control (CNC) machine, the computer numerical control machine can provide advantages of high machining accuracy, low cost, and high productivity compared with traditional machines.

The computer numerical control machine can implement various cuttings through replacing different tool heads. During the cutting process, it needs to operate another machine at welding or heat treatment. Especially, in the laser process, for example, during the laser cladding process, it needs to operate a laser machine.

However, when the machines are operated in the metalworking process, a workpiece needs to be moved, fixed, and machined between the machines. Then, the workpiece is repeated to move, fix, and machine. It causes the machine time to be greatly increased. In addition, the computer numerical control machine needs some time to replace tools if a laser process is adopted, wherein the subtractive process of mechanical, the subtractive process of laser and the addition process of laser cannot be implemented at the same time. Thus, the machining efficiency of the computer numerical control machine is limited.

As a result, it is necessary to provide a combined machining apparatus to solve the problems existing in the conventional technologies, as described above.

### SUMMARY OF THE INVENTION

An object of the present disclosure is to provide a combined machining apparatus, wherein laser beams can be generated by using a laser spectroscopic device for machining a workpiece, and a spindle can selectively assemble a tool head or a feeding head, so that attachment and replacement of tools can be reduced, machining time can be decreased, and machining efficiency can be improved.

To achieve the above objects, the present disclosure provides a combined machining apparatus. The combined machining apparatus comprises a machining platform, a machining device and a laser spectroscopic device, wherein the machining platform is configured to place a workpiece, and the machining device includes a body and a spindle mounted on the body, wherein the spindle is configured to selectively assemble a tool head or a feeding head. The laser spectroscopic device is disposed at a side of the spindle and comprising: a laser splitting module configured to split a main laser into at least two laser beams; and at least two laser outlets configured to output the laser beams to the workpiece, respectively.

In one embodiment of the present disclosure, the laser splitting module includes: an incident lens configured to introduce the main laser; a laser splitting box configured to split the main laser into the laser beams; and at least two transmitting channels configured to guide the laser beams to the laser outlets, respectively.

In one embodiment of the present disclosure, the laser splitting module further includes a plurality of reflecting mirrors disposed in the transmitting channels and configured to reflect the laser beams to corresponding laser outlets.

In one embodiment of the present disclosure, the laser spectroscopic device further includes two positioning module connected to the transmitting channels, respectively, and configured to adjust a heat affected zone of each of the laser outlets.

In one embodiment of the present disclosure, the combined machining apparatus further comprises a movement unit including an X-axis slider and a Y-axis slider, wherein the machining platform is moveably assembled on the X-axis slider, and the X-axis slider is moveably assembled on the Y-axis slider.

In one embodiment of the present disclosure, the movement unit further includes a Z-axis slider, and the body of the machining device is moveably assembled on the Z-axis slider.

To achieve the above objects, the present disclosure provides a laser spectroscopic device disposed at a side of a spindle of a machining device. The laser spectroscopic device comprises a laser splitting module and at least two laser outlets, wherein the laser splitting module surrounds the spindle and is configured to split a main laser into at least two laser beams, wherein the laser splitting module includes: an incident lens configured to introduce the main laser; a laser splitting box disposed at a side of the incident lens; and at least two transmitting channels disposed at two opposite sides of the laser splitting box and configured to guide the laser beams to the laser outlets, respectively; wherein the laser splitting box includes a diffractive component configured to split a main laser into at least two laser beams and a split reflecting mirror configured to reflect the laser beams into the transmitting channels, respectively. The laser outlets are communicated with the transmitting channels and configured to output the laser beams.

In one embodiment of the present disclosure, the laser outlets are located at two opposite sides of the spindle, and each of the laser outlets is provided with a focusing lens.

In one embodiment of the present disclosure, the laser spectroscopic device further comprises two positioning modules connected to the transmitting channels, respectively, and configured to adjust a heat affected zone of each of the laser outlets.

In one embodiment of the present disclosure, each of the positioning modules includes: a telescopic portion configured to linearly adjust the heat affected zone of one of the laser outlets; and a rotating portion configured to rotatably adjust the heat affected zone of the laser outlet.

As described above, the laser beams can be generated by using the laser spectroscopic device for machining the workpiece, and the spindle can selectively assemble the tool head or the feeding head. Thus, the subtractive process of mechanical, the subtractive process of laser and the addition process of laser can be implemented. Combining the subtractive process of mechanical, the subtractive process of laser and the addition process of laser can achieve the purpose for combined machining the workpiece. In addition, attachment and replacement of tools can be reduced, so that machining time can be decreased, and machining efficiency can be improved.

### DESCRIPTION OF THE DRAWINGS

FIG. 1 is a perspective view of a combined machining apparatus according to a preferred embodiment of the present disclosure.

FIG. 2 is a perspective view of a laser spectroscopic device of the combined machining apparatus according to a preferred embodiment of the present disclosure.

FIG. 3 is a top view of a laser spectroscopic device of the combined machining apparatus according to a preferred embodiment of the present disclosure.

FIG. 4 is a perspective view of a combined machining apparatus according to another preferred embodiment of the present disclosure.

FIGS. 5 and 6 is a perspective view of a combined machining apparatus according to a further preferred embodiment of the present disclosure.

### DETAILED DESCRIPTION OF THE PREFERRED EMBODIMENTS

The structure and the technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, etc., are only directions by referring to the accompanying drawings, and thus the used directional terms are used to describe and understand the present disclosure, but the present disclosure is not limited thereto.

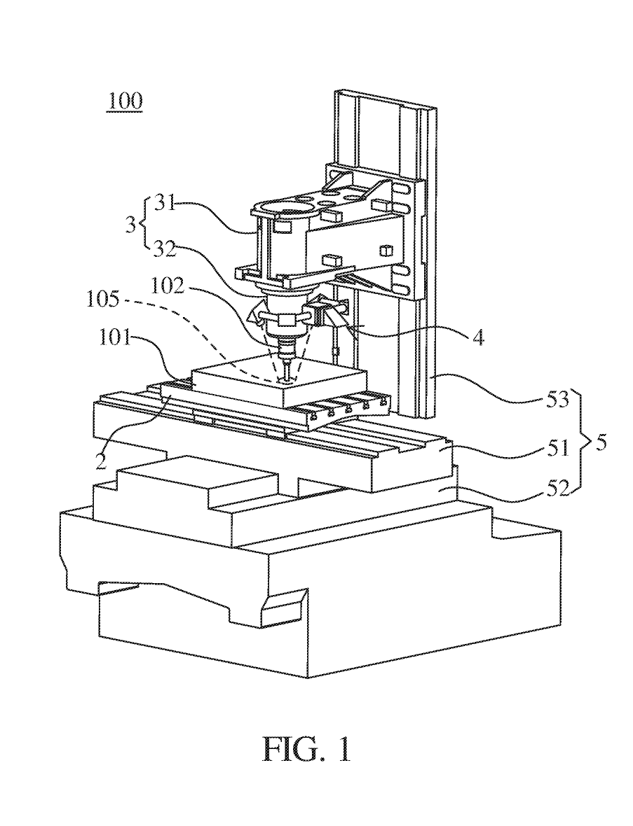

Referring to FIG. 1, a combined machining apparatus 100 according to a preferred embodiment of the present disclosure is illustrated, and used in computer numerical control (CNC) machine, wherein the combined machining apparatus 100 is configured to combined machine a workpiece 101 by adopting an addition process or a subtractive process. The combined machining apparatus 100 comprises a machining platform 2, a machining device 3, a laser spectroscopic device 4, and a movement unit 5. The detailed structure of each component, assembly relationships, and principle of operation in the present invention will be described in detail hereinafter.

Referring to FIG. 1, the machining platform 2 is configured to place the workpiece 101, wherein the machining platform 2 is disposed under the machining device 3, and the machining platform 2 and the machining device 3 are spaced apart from each other.

Referring to FIG. 1, the machining device 3 includes a body 31 and a spindle 32, wherein the spindle 32 is mounted on the body 31, and a bottom of the spindle 32 is configured to assemble a tool head 102, wherein tool head 102 is configured to selectively assemble a milling tool or a turning tool.

Referring to FIGS. 1 to 3, the laser spectroscopic device 4 is disposed at a side of the spindle 32 of the machining device 3, wherein the laser spectroscopic device 4 comprises a laser splitting module 41, two laser outlets 42, and two positioning modules 43. The laser splitting module 41 is configured to split a main laser from a laser source (not shown) into two laser beams 104. The laser outlets 42 are located at two opposite sides of the spindle 32, and the laser outlets 42 are configured to output the laser beams 104 to the workpiece 101, respectively. The positioning modules 43 are disposed on the laser splitting module 41, and configured to adjust a heat affected zone 105 (laser spot) of each of the laser outlets 42, wherein the laser beams 104 can be general beams or coupling beams.

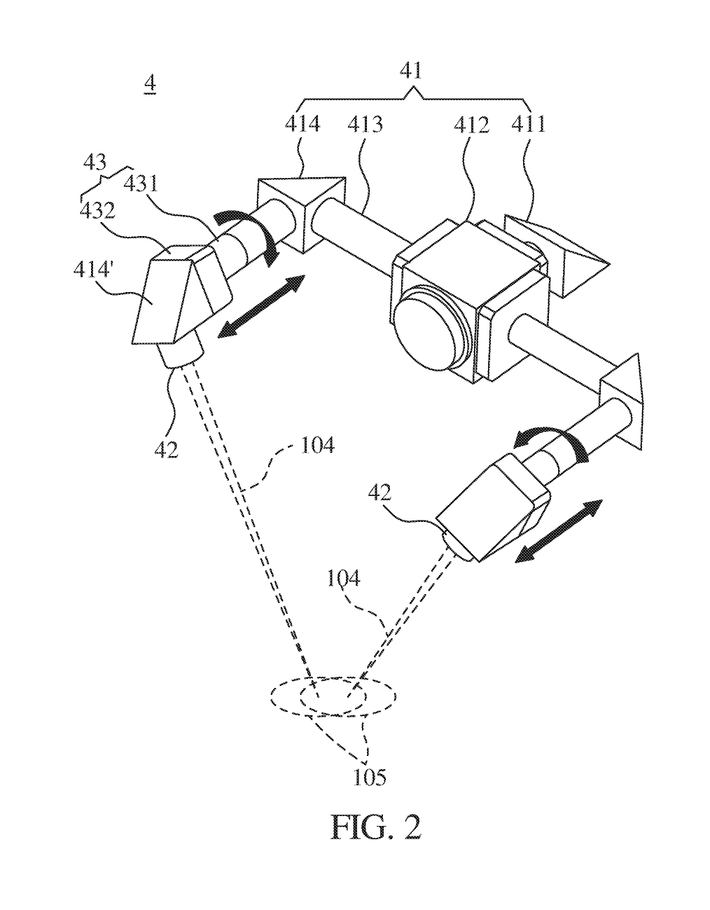

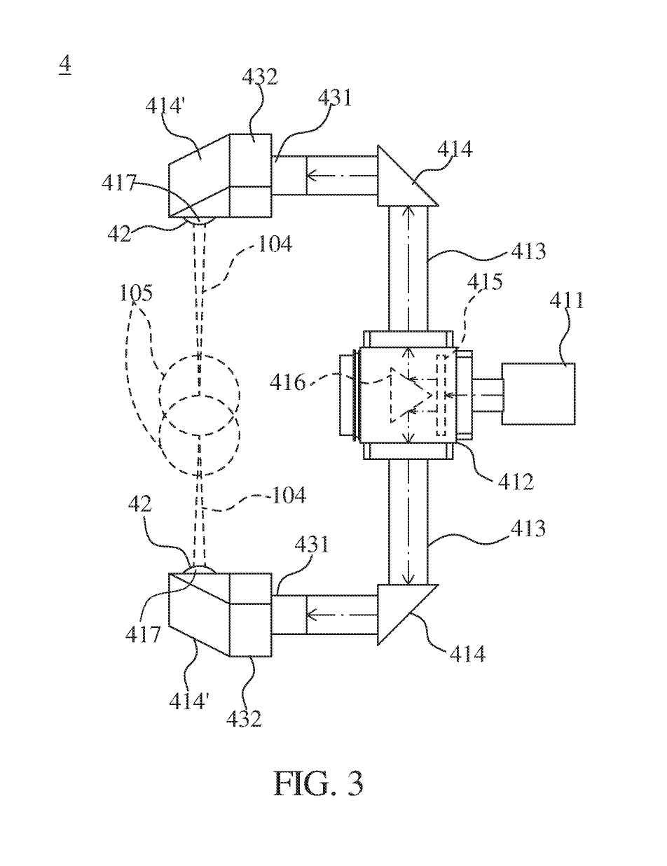

Referring to FIGS. 2 to 3, specifically, the laser splitting module 41 includes an incident lens 411, a laser splitting box 412, two transmitting channels 413, and a plurality of reflecting mirrors, wherein the incident lens 411 is configured to introduce the main laser from the laser source. The laser splitting box 412 is disposed at a side of the incident lens 411 and configured to split the main laser into the laser beams 104, wherein the laser splitting box 412 includes a diffractive component 415 and a split reflecting mirror 416. The diffractive component 415 is configured to split a main laser into two laser beams 104. The split reflecting mirror 416 is configured to reflect the laser beams into the transmitting channels 413, respectively. The transmitting channels 413 are disposed at two opposite sides of the laser splitting box 412, and configured to guide the laser beams 104 to the laser outlets 42, respectively. The reflecting mirrors 414 are disposed in the transmitting channels 413 and configured to reflect the laser beams 104 to corresponding laser outlets 42. In addition, each of the laser outlets 42 is provided with a focusing lens 417, wherein the focusing lens 417 is configured to focus the laser beam 104 and to project the laser beam 104 to the heat affected zone 105 from the laser outlet 42.

Referring to FIGS. 2 to 3, each of the positioning modules 43 includes a telescopic portion 431 and a rotating portion 432. As shown in FIG. 2, the telescopic portion 431 is disposed on the corresponding transmitting channel 413, and reciprocally moved along an arrow direction, and configured to linearly adjust the heat affected zone 105 of one of the laser outlets 42. The rotating portion 432 is pivoted on the telescopic portion 431, and reciprocally rotated along another arrow direction, and configured to rotatably adjust the heat affected zone 105 of the laser outlet 42 through another reflecting mirrors 414′.

Referring to FIG. 1, the movement unit 5 includes an X-axis slider 51, a Y-axis slider 52, and Z-axis slider 53, wherein the machining platform 2 is moveably assembled on the X-axis slider 51, and moved along an X axis direction on the X-axis slider 51. The X-axis slider 51 is moveably assembled on the Y-axis slider 52, and moved along a Y axis direction on the Y-axis slider 52. The body 31 of the machining device 3 is moveably assembled on the Z-axis slider 53, and moved along a Z axis direction on the Z-axis slider 53. Therefore, the spindle 32 can move to anyplace above the workpiece 101 through the movement unit 5 move.

According to the described structure and referring to FIG. 1, the movement unit 5 is controlled by a controller (not shown) to adjust the position of the spindle 32 above the workpiece 101. Then, the telescopic portion 431 and the rotating portion 432 of the positioning modules 43 are controlled, so that the heat affected zone 105 of laser beams 104 are allowed to move on the workpiece 101, and the material on the workpiece 101 can be partially removed through the laser beams 104. In addition, the tool head 102 assembled on the spindle 32 can be processed by adopting the subtractive process through the milling tools or the turning tools, such as cutting, drilling, and milling. Thus, the purpose for adopting a variety of subtractive processes can be achieved, and attachment and replacement of tools can be reduced.

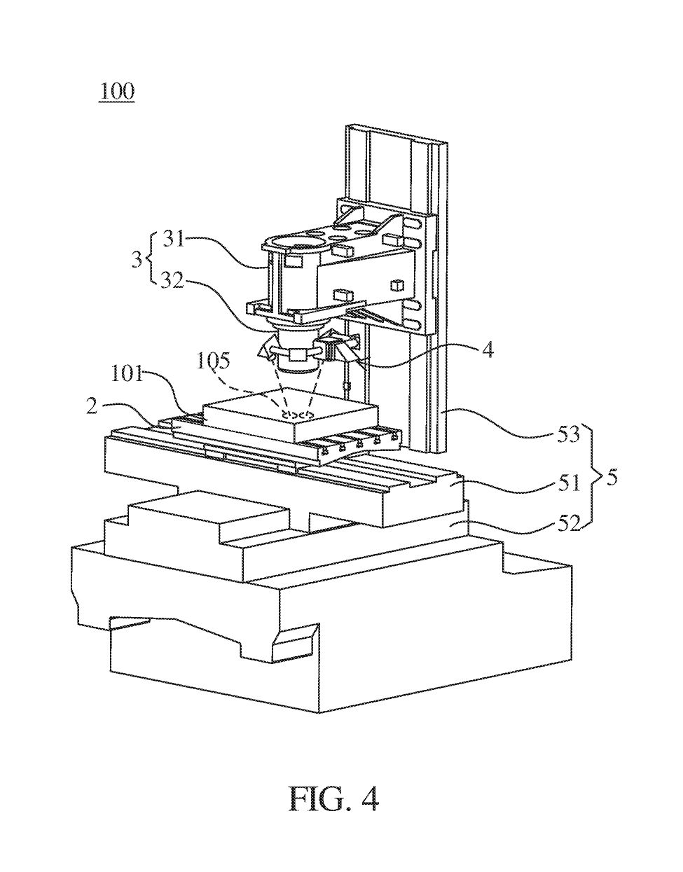

Referring to FIG. 4, a combined machining apparatus 100 according to another preferred embodiment can only machine the workpiece 101 through the laser spectroscopic device 4. In other words, the heat affected zone 105 of laser beams 104 are allowed to move on the workpiece 101 by controlling the telescopic portion 431 and the rotating portion 432 of the positioning modules 43, thus the workpiece 101 can be processed by adopting the subtractive process, such as drilling, cutting, marking and surface treatment.

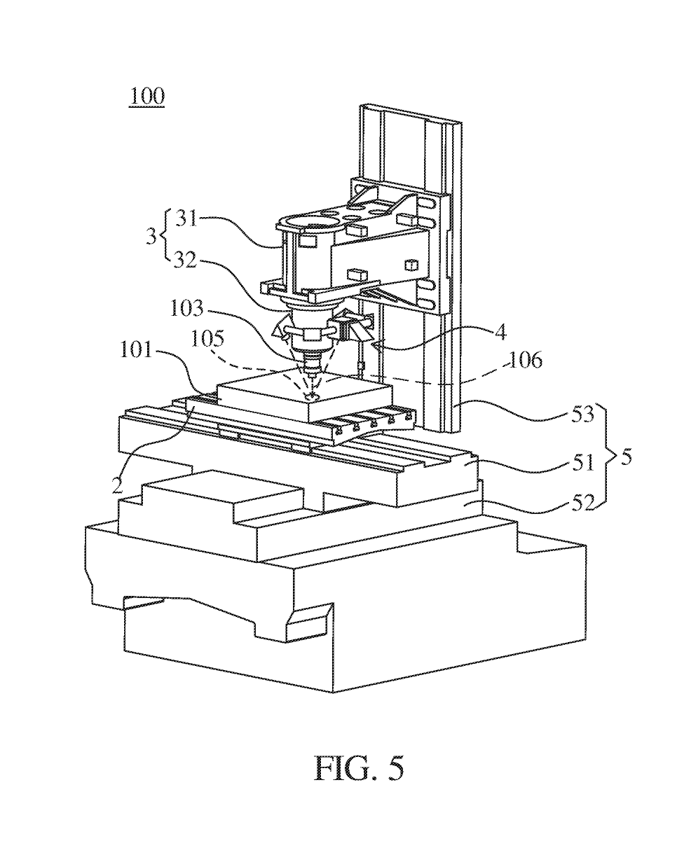

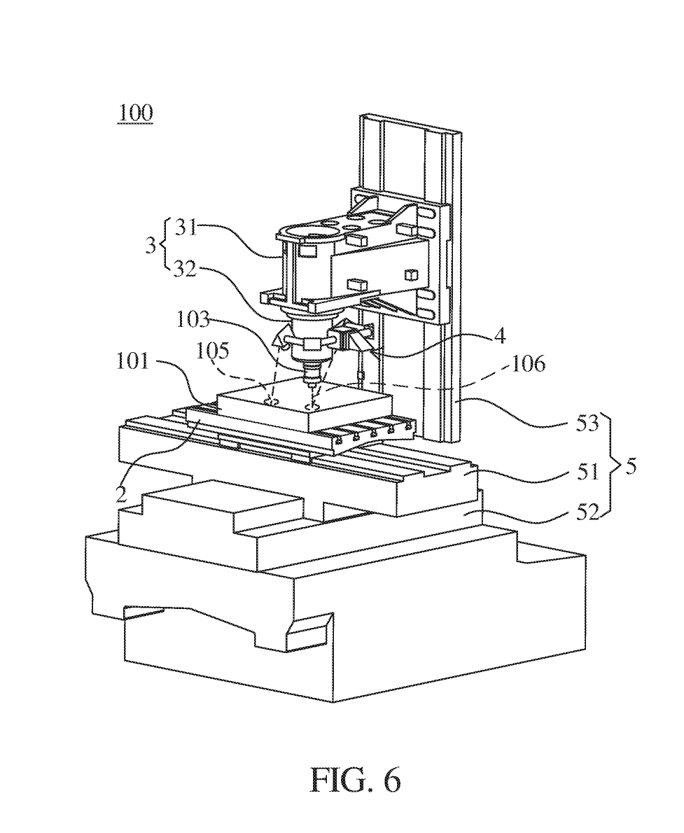

Referring to FIGS. 5 and 6, a further preferred embodiment is proved, wherein the bottom of the spindle 32 is configured to assemble a tool head 102, wherein tool head 102 can be configured to assemble a feeding head 103. The feeding head 103 can deposit powdery, gel, or wire feeding to the workpiece 101. As shown in FIG. 5, the heat affected zone 105 of laser beams 104 are allowed to move on the workpiece 101 by controlling the telescopic portion 431 and the rotating portion 432 of the positioning modules 43. Simultaneously, the material 106 of the feeding head 103 is melted or sintered to the workpiece 101, thus the workpiece 101 can be processed by adopting the addition process, such as layered manufacturing, welding, and repairing, wherein the material 106 is fed from powdery, gel, or wire feeding. As shown in FIG. 6, the laser beams 104 can be processed by adopting the addition process or the subtractive process through adjusting the heat affected zone 105 of laser beams 104.

As described above, the laser beams 104 can be generated by using the laser spectroscopic device 4 for machining the workpiece 101, and the spindle 32 can selectively assemble the tool head 102 or the feeding head 103. Thus, the subtractive process of mechanical, the subtractive process of laser and the addition process of laser can be implemented. Combining the subtractive process of mechanical, the subtractive process of laser and the addition process of laser can achieve the purpose for combined machining the workpiece 101. In addition, attachment and replacement of tools can be reduced, so that machining time can be decreased, and machining efficiency can be improved.

The present disclosure has been described with preferred embodiments thereof and it is understood that many changes and modifications to the described embodiments can be carried out without departing from the scope and the spirit of the invention that is intended to be limited only by the appended claims.

What is claimed is:

1. A combined machining apparatus, comprising:
a machining platform configured to place a workpiece;
a machining device including a body and a spindle mounted on the body, wherein the spindle is configured to selectively assemble a tool head or a feeding head; and
a laser spectroscopic device disposed at a side of the spindle and comprising: a laser splitting module configured to split a main laser into at least two laser beams; and at least two laser outlets configured to output the laser beams to the workpiece, respectively.

2. The combined machining apparatus according to claim 1, wherein the laser splitting module includes: an incident lens configured to introduce the main laser; a laser splitting box configured to split the main laser into the laser beams; and at least two transmitting channels configured to guide the laser beams to the laser outlets, respectively.

3. The combined machining apparatus according to claim 2, wherein the laser splitting module further includes a plurality of reflecting mirrors disposed in the transmitting channels and configured to reflect the laser beams to corresponding laser outlets.

4. The combined machining apparatus according to claim 2, wherein the laser spectroscopic device further includes two positioning module connected to the transmitting channels, respectively, and configured to adjust a heat affected zone of each of the laser outlets.

5. The combined machining apparatus according to claim 1, wherein the combined machining apparatus further comprises a movement unit including an X-axis slider and a Y-axis slider, wherein the machining platform is moveably assembled on the X-axis slider, and the X-axis slider is moveably assembled on the Y-axis slider.

6. The combined machining apparatus according to claim 5, wherein the movement unit further includes a Z-axis slider, and the body of the machining device is moveably assembled on the Z-axis slider.

7. A laser spectroscopic device disposed at a side of a spindle of a machining device, comprising:
a laser splitting module surrounding the spindle and configured to split a main laser into at least two laser beams, wherein the laser splitting module includes:
an incident lens configured to introduce the main laser;
a laser splitting box disposed at a side of the incident lens; and
at least two transmitting channels disposed at two opposite sides of the laser splitting box and configured to guide the laser beams to the laser outlets, respectively;
wherein the laser splitting box includes a diffractive component configured to split a main laser into at least two laser beams and a split reflecting mirror configured to reflect the laser beams into the transmitting channels, respectively; and
at least two laser outlets communicated with the transmitting channels and configured to output the laser beams.

8. The laser spectroscopic device according to claim 7, wherein the laser outlets are located at two opposite sides of the spindle, and each of the laser outlets is provided with a focusing lens.

9. The laser spectroscopic device according to claim 7, wherein the laser spectroscopic device further comprises two positioning modules connected to the transmitting channels, respectively, and configured to adjust a heat affected zone of each of the laser outlets.

10. The laser spectroscopic device according to claim 9, wherein each of the positioning modules includes: a telescopic portion configured to linearly adjust the heat affected zone of one of the laser outlets; and a rotating portion configured to rotatably adjust the heat affected zone of the laser outlet.
